(19) United States
(12) Patent Application Publication
(10) Pub. No.: US 2026/0137124 A1
(43) Pub. Date: May 21, 2026

(54) ATOMIZATION CORE, ATOMIZER, AND ELECTRONIC ATOMIZATION APPARATUS

(71) Applicant: SMOORE INTERNATIONAL HOLDINGS LIMITED, George Town (KY)

(72) Inventors: Boxue GONG, Shenzhen (CN); Ying ZHANG, Shenzhen (CN); Wenjie QI, Shenzhen (CN); Yongpeng WU, Shenzhen (CN)

(21) Appl. No.: 19/389,997

(22) Filed: Nov. 14, 2025

(30) Foreign Application Priority Data
Nov. 18, 2024 (CN) 202411651049.3

(51) Int. Cl. A24F 40/44; A24F 40/10; A24F 40/46; A24F 40/50; H05B 3/22

(52) U.S. Cl. CPC A24F 40/44; A24F 40/10; A24F 40/46; A24F 40/50; H05B 3/22

(57) ABSTRACT

An atomization core includes: a dense substrate liquid guiding layer having a liquid inlet surface and a liquid outlet surface that are oppositely disposed, a first microporous structure that penetrates through the liquid inlet surface and the liquid outlet surface being provided on the dense substrate liquid guiding layer, the first microporous structure conducting and buffering a to-be-atomized substrate; a porous cover layer disposed on a liquid outlet surface side of the dense substrate liquid guiding layer, the porous cover layer having a liquid supply portion having a second microporous structure, at least part of the first microporous structure in the dense substrate liquid guiding layer being in fluid communication with the second microporous structure, a porosity of the liquid supply portion being greater than a porosity of the dense substrate liquid guiding layer.

### CROSS-REFERENCE TO PRIOR APPLICATION

Priority is claimed to Chinese Patent Application No. 202411651049.3, filed on Nov. 18, 2024, the entire disclosure of which is hereby incorporated by reference herein.

### FIELD

This application relates to the technical field of electronic atomization, and in particular, to an atomization core, an atomizer, and an electronic atomization apparatus.

### BACKGROUND

The electronic atomization apparatus generally includes an atomizer and a main unit that are electrically connected to each other. The atomizer includes a liquid storage cavity and an atomization core. The liquid storage cavity stores a to-be-atomized substrate, and the atomization core is configured to atomize the to-be-atomized substrate to form an aerosol smokable by a user; and the main unit is configured to supply power to the atomizer and control the atomizer to work. Currently, mainstream atomization cores on the market includes two types: cotton cores and rigid atomization cores (for example, ceramics cores).

A cotton core has a relatively large pore diameter and a relatively large porosity, and large aerosol particles are easily generated. These large aerosol particles easily deposit in an oral cavity, thereby improving a taste experience in the oral cavity of a user. However, the cotton core is easily burnt, resulting in an odor, and short service life. A ceramic core has advantages of long service life and a fine and smooth taste, and has relatively fewer large aerosol particles compared with the cotton core, resulting in that the taste experience in the oral cavity of the user is to be improved.

### SUMMARY

In an embodiment, the present invention provides an atomization core, comprising: a dense substrate liquid guiding layer having a liquid inlet surface and a liquid outlet surface that are oppositely disposed, a first microporous structure that penetrates through the liquid inlet surface and the liquid outlet surface being provided on the dense substrate liquid guiding layer, the first microporous structure being configured to conduct and buffer a to-be-atomized substrate; a porous cover layer disposed on a liquid outlet surface side of the dense substrate liquid guiding layer, the porous cover layer having a liquid supply portion having a second microporous structure, at least part of the first microporous structure in the dense substrate liquid guiding layer being in fluid communication with the second microporous structure, a porosity of the liquid supply portion being greater than a porosity of the dense substrate liquid guiding layer, and an equivalent diameter of the second microporous structure being greater than an equivalent diameter of the first microporous structure; and a heating element disposed between the dense substrate liquid guiding layer and the liquid supply portion, the heating element being configured to atomize the to-be-atomized substrate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic atomization apparatus according to an embodiment of this application;

FIG. 2 is a structural sectional view of an atomizer according to an embodiment of this application;

FIG. 3 is a schematic structural diagram of an atomization core according to an embodiment of this application;

FIG. 4 is a schematic structural diagram of an atomization core according to another embodiment of this application;

FIG. 5 is an exploded view of a structure of an atomization core according to an embodiment of this application;

FIG. 6 is an exploded view of an atomization core according to another embodiment of this application;

FIG. 7 is a structural schematic diagram of a porous cover layer according to an embodiment of this application; and

FIG. 8 is a schematic structural diagram of an atomization core according to still another embodiment of this application.

### DETAILED DESCRIPTION

In an embodiment, the present invention provides an atomization core, an atomizer, and an electronic atomization apparatus that can resolve a problem that an existing rigid atomization core generates relatively few large aerosol particles, resulting in poor taste experience in the oral cavity of a user.

In an embodiment, the present invention provides an atomization core, including:
a dense substrate liquid guiding layer, having a liquid inlet surface and a liquid outlet surface that are oppositely disposed, a first microporous structure that penetrates through the liquid inlet surface and the liquid outlet surface being provided on the dense substrate liquid guiding layer, and the first microporous structure being configured to conduct and buffer a to-be-atomized substrate;
a porous cover layer, disposed on the liquid outlet surface side of the dense substrate liquid guiding layer; the porous cover layer having a liquid supply portion, and the liquid supply portion having a second microporous structure; at least part of the first microporous structure in the dense substrate liquid guiding layer being in fluid communication with the second microporous structure, where the porosity of the liquid supply portion is greater than that of the dense substrate liquid guiding layer, and the equivalent diameter of the second microporous structure is greater than that of the first microporous structure; and
a heating element, disposed between the dense substrate liquid guiding layer and the liquid supply portion, the heating element being configured to atomize the to-be-atomized substrate.

In some embodiments, the porosity of the liquid supply portion is at least twice greater than that of the dense substrate liquid guiding layer; and/or
the equivalent diameter of the second microporous structure in the porous cover layer is at least twice greater than that of the first microporous structure in the dense substrate liquid guiding layer.

In some embodiments, the heating element includes a heating portion and a pin portion, and the heating portion is configured to atomize the to-be-atomized substrate; and
the porosity of the area of the liquid supply portion aligned with the heating portion is greater than or equal to 50%.

In some embodiments, the equivalent diameter of the second microporous structure ranges from 100 μm to 1500 μm.

In some embodiments, the thickness of the liquid supply portion ranges from 20 μm to 400 μm.

In some embodiments, the orthographic projection of the liquid supply portion on the dense substrate liquid guiding layer covers the orthographic projection of the heating portion of the heating element on the dense substrate liquid guiding layer.

In some embodiments, the spacing between the heating portion and the liquid supply portion ranges from 0 to 200 μm.

In some embodiments, the porous cover layer further includes a support portion located outside the area of the liquid supply portion, the support portion is of a continuous and seamless structure, and the support portion and the liquid supply portion are located on the same horizontal plane.

The surface of the support portion close to the dense substrate liquid guiding layer has a protruding portion, and the heating portion is spaced away from the liquid supply portion by the protruding portion.

In some embodiments, the material of the porous cover layer includes at least one of quartz glass, metal, ceramics, a cotton core, and a fiber braid material.

In some embodiments, the porous cover layer is fixedly connected to the dense substrate liquid guiding layer.

In some embodiments, the cross section of the second microporous structure is at least one of a strip, a circle, an ellipse, a rhombus, or a rectangle.

To resolve the foregoing technical problem, a second technical solution provided in this application is that: an atomizer is provided, including:
a housing, having a liquid storage cavity; and
an atomization core, being in fluid communication with the liquid storage cavity, where the atomization core is the atomization core according to any one of the foregoing items.

To resolve the foregoing technical problem, a third technical solution provided in this application is that: an electronic atomization apparatus is provided, including:
an atomizer, the atomizer being the foregoing atomizer; and
a main unit, configured to supply power to the atomizer and control the atomizer to work.

This application has the following beneficial effects that: different from a related technology, in the atomization core provided in this application, the atomization core includes the dense substrate liquid guiding layer, the porous cover layer, and the heating element disposed between the dense substrate liquid guiding layer and the porous cover layer. The dense substrate liquid guiding layer has the liquid inlet surface and the liquid outlet surface that are oppositely disposed, the first microporous structure that penetrates through the liquid inlet surface and the liquid outlet surface is provided on the dense substrate liquid guiding layer, and the first microporous structure is configured to conduct and buffer a to-be-atomized substrate; the porous cover layer is disposed on the liquid outlet surface side of the dense substrate liquid guiding layer; the porous cover layer has a liquid supply portion, and the liquid supply portion has a second microporous structure; and at least part of the first microporous structure of the dense substrate liquid guiding layer is in fluid communication with the second microporous structure, where the porosity of the liquid supply portion is greater than that of the dense substrate liquid guiding layer, and the equivalent diameter of the second microporous structure is greater than that of the first microporous structure. Specifically, the porous cover layer is further disposed on the rigid dense substrate liquid guiding layer, and the porosity of the liquid supply portion of the porous cover layer is greater than that of the dense substrate liquid guiding layer; and the equivalent diameter of the second microporous structure is greater than that of the first microporous structure, and the liquid supply portion can form a thicker liquid film by using the surface tension of liquid, thereby cracking to form relatively large-sized atomized liquid drops in an atomization process, facilitating improving the taste of aerosols generated by the rigid atomization core, and improving user experience.

Technical solutions in embodiments of this application are clearly and completely described below with reference to the accompanying drawings in the embodiments of this application. Apparently, the described embodiments are merely part rather than all of the embodiments of this application. Based on the embodiments in this application, all other embodiments obtained by those of ordinary skill in the art without creative work fall within the scope of protection of this application.

In the following description, for the purpose of illustration rather than limitation, specific details such as a specific system structure, interface, and technology are proposed to thoroughly understand this application.

Terms “first”, “second”, and “third” are merely used for the purpose of description, and cannot be construed as indicating or implying relative importance or implying a quantity of indicated technical features. Therefore, features defining “first”, “second”, and “third” can explicitly or implicitly include at least one of the features. In description of this application, “a plurality of” means at least two, such as two and three unless otherwise explicitly and specifically defined. All directional indications (for example, upper, lower, left, right, front, and back) in the embodiments of this application are merely used for explaining relative position relationships, movement situations, or the like between various components in a specific posture (as shown in the accompanying drawings). If the specific posture changes, the directional indications change correspondingly. In the embodiments of this application, terms “include”, “have”, and any variant thereof are intended to cover non-exclusive inclusion. For example, a process, method, system, product, or device that includes a series of steps or units is not limited to the listed steps or units, but further optionally includes a step or unit that is not listed, or further optionally includes another step or component that is intrinsic to the process, method, product, or device.

“Embodiment” mentioned in the specification means that particular features, structures, or characteristics described with reference to the embodiment may be included in at least one embodiment of this application. The term appearing at different positions of this specification may not refer to the same embodiment or an independent or alternative embodiment that is mutually exclusive with another embodiment. Those skilled in the art explicitly and implicitly understand that the embodiments described herein may be combined with other embodiments.

The following describes this application in detail with reference to the accompanying drawings and embodiments.

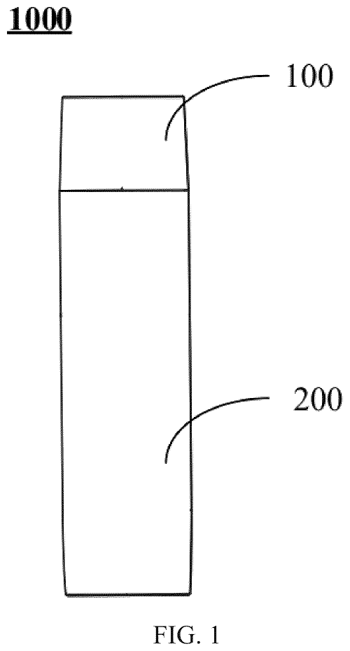

Refer to FIG. 1, which is a schematic structural diagram of an electronic atomization apparatus according to an embodiment of this application. In this embodiment of this application, an electronic atomization apparatus 1000 is provided. The electronic atomization apparatus 1000 may be configured to atomize a to-be-atomized substrate. The electronic atomization apparatus 1000 includes an atomizer 100 and a main unit 200 that are electrically connected to each other.

The atomizer 100 is configured to store the to-be-atomized substrate and atomize the to-be-atomized substrate to form an aerosol smokable by a user. The atomizer 100 may be specifically applied to different fields such as medical care, cosmetology, and recreational smoking.

The following embodiment uses an example in which the atomizer 100 is applied to recreational smoking. Certainly, in another embodiment, the atomizer 100 may alternatively be applied to a hair spray device to atomize hair spray for setting hair, or applied to a device for the treatment of respiratory system diseases to atomize a medical medicine. Details are not described herein.

For a specific structure and functions of the atomization core 100, refer to the specific structure and functions of the atomization core 100 involved in the following embodiments, and the same or similar technical effects can be achieved. Details are not described herein.

The main unit 200 is configured to supply power to the atomizer 100 and control the atomizer to work. In an embodiment, the main unit 200 includes a battery and a controller. The battery is configured to supply power to the atomizer 100, so that the atomizer 100 can atomize a to-be-atomized substrate to form an aerosol. The controller is configured to control the atomizer 100 to work. The main unit 200 may further include, but is not limited to, functional elements such as a battery holder and an airflow sensor.

The atomizer 100 and the main unit 200 may be integrally disposed, for example, a disposable electronic atomization apparatus, which can be discarded after use. The atomizer 100 and the main unit 200 may alternatively be detachably connected. For example, after the to-be-atomized substrate in the atomizer 100 is used up, the atomizer 100 may be detached from the main unit 200, thereby facilitating replacing a new atomizer 100 or refilling the atomizer 100. A specific design may be designed as required.

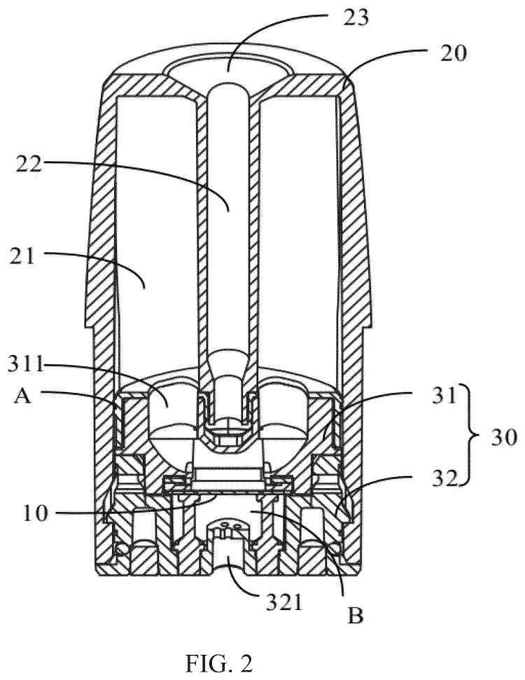

Refer to FIG. 2, which is a structural sectional view of an atomizer according to an embodiment of this application. Specifically, in this embodiment of this application, an atomizer 100 includes a housing 20 and an atomization core 10.

The housing 20 has a liquid storage cavity 21. The liquid storage cavity 21 is configured to store a to-be-atomized substrate.

Based on the field to which the atomizer 100 is applied, the to-be-atomized substrate may be a medical liquid, a dietary liquid, a cosmetic liquid, a combined oil substance with a specific aroma, or the like. This is not limited herein.

In this embodiment of this application, the atomization core 10 is a rigid atomization core. The atomization core 10 is in fluid communication with the liquid storage cavity 21, and is configured to heat and atomize the to-be-atomized substrate conducted from the liquid storage cavity 21, for a user to use. For a specific structure and functions of the atomizer 10, refer to the specific structure and functions of the atomizer 10 involved in the following embodiments, and the same or similar technical effects can be achieved. Details are not described herein.

In this embodiment of this application, the atomizer 100 further includes an atomization base 30. Specifically, the housing 20 has a liquid storage cavity 21 and an air outlet channel 22. The liquid storage cavity 21 is configured to store the to-be-atomized substrate in a liquid state, and the liquid storage cavity 21 is disposed around the air outlet channel 22. The end of the housing 20 further has a suction nozzle 23, and the suction nozzle 23 communicates with the air outlet channel 22. Specifically, a port of the air outlet channel 22 may form the suction nozzle 23. The housing 20 has an accommodating cavity A on one side of the liquid storage cavity 21 that faces away from the suction nozzle 23, and the atomization base 30 is disposed in the accommodating cavity A. The atomization base 30 includes an atomization top base 31 and an atomization bottom base 32. The atomization top base 31 and the atomization bottom base 32 fit to form an accommodating cavity 33. That is, the atomization base 30 has an accommodating cavity 33. The atomization core 10 is disposed in the accommodating cavity 33, and is disposed in the accommodating cavity A together with the atomization base 30.

A liquid discharging channel 311 is provided on the atomization top base 31. One end of the liquid discharging channel 311 is communicated with the liquid storage cavity 21, and the other end is communicated with the accommodating cavity 33. That is, the liquid storage cavity 21 is communicated with the accommodating cavity 33 through the liquid discharging channel 311, so that the to-be-atomized substrate in the liquid storage cavity 21 enters the atomization core 10 through the liquid discharging channel 311. That is, the atomization core 10 is in fluid communication with the liquid storage cavity 21, and the atomization core 10 is configured to absorb and heat the to-be-atomized substrate.

In this embodiment, an atomization cavity B is formed between the atomization core 10 and the inner wall surface of the accommodating cavity 33, and the atomization cavity B is communicated with the air outlet channel 22. An air inlet 321 is provided on the atomization bottom base 32, so that the outside is communicated with the atomization cavity B. External air enters the atomization cavity B through the air inlet 321, carries the aerosol atomized by the atomization core 10 to enter the air outlet channel 22, and finally reaches the suction nozzle 23 for a user to smoke.

As described in the background, relatively fewer large aerosol particles are generated by a rigid atomization core (for example, a ceramic core) compared with a cotton core, resulting in that the taste experience in the oral cavity of the user is to be improved.

In view of this, the applicant finds that there is less to-be-atomized substrate on the surface of the heating element during atomizing by the rigid atomization core, so the less to-be-atomized substrate is easy to be completely atomized, but cannot be cracked to form relatively large-sized atomized liquid drops. Consequently, the generated aerosols have poor taste, are difficult to meet user experience.

It is further found through research that a reason why there is less to-be-atomized substrate on the surface of the heating element is to avoid liquid leakage of the electronic atomization apparatus. Generally, the size of the liquid guiding micro-pores on the liquid guiding layer in the atomization core is set to be relatively small to improve a liquid locking capability.

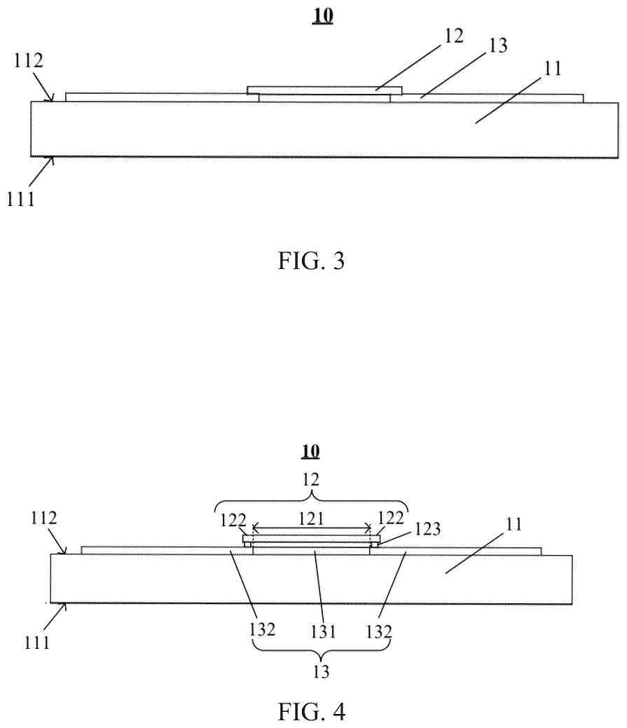

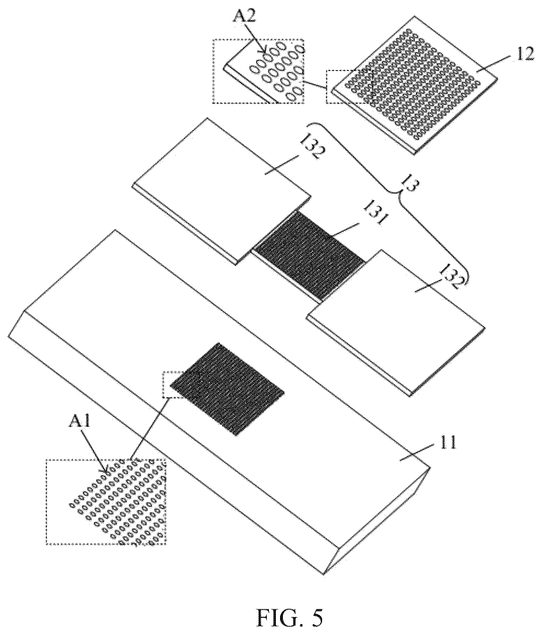

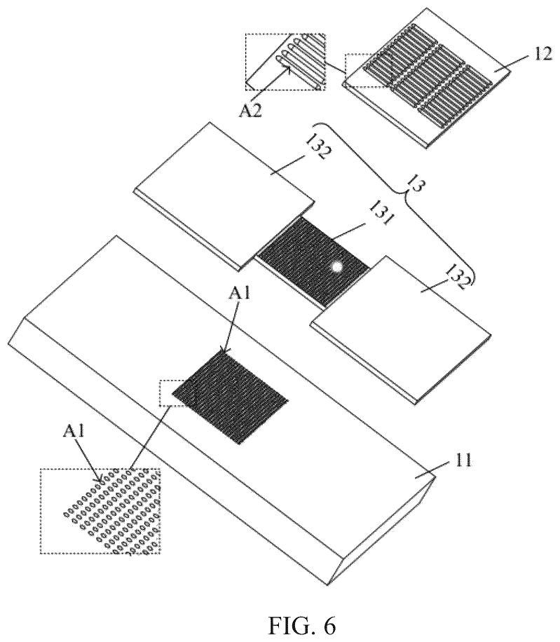

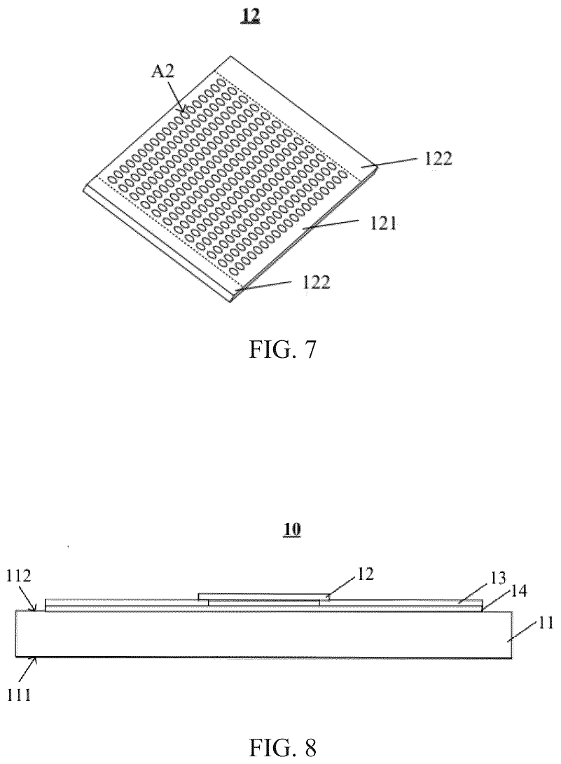

Referring to FIG. 3 to FIG. 7, FIG. 3 is a schematic structural diagram of an atomization core according to an embodiment of this application; FIG. 4 is a schematic structural diagram of an atomization core according to another embodiment of this application; FIG. 5 is an exploded view of a structure of an atomization core according to an embodiment of this application; FIG. 6 is an exploded view of a structure of an atomization core according to another embodiment of this application; and FIG. 7 is a schematic diagram of a structure of a porous cover layer according to an embodiment of this application.

To resolve the foregoing problem, this application provides an atomization core 10. The atomization core 10 includes a dense substrate liquid guiding layer 11, a porous cover layer 12, and a heating element 13 disposed between the dense substrate liquid guiding layer 11 and the porous cover layer 12.

The dense substrate liquid guiding layer 11 has a liquid inlet surface 111 and a liquid outlet surface 112 that are oppositely disposed, and a first microporous structure A1 that penetrates through the liquid inlet surface 111 and the liquid outlet surface 112 is provided on the dense substrate liquid guiding layer 11. The first microporous structure A1 is configured to conduct a to-be-atomized substrate in the liquid storage cavity 21 and buffer the to-be-atomized substrate. The porosity of the dense substrate liquid guiding layer 11 and the equivalent diameter of the first microporous structure A1 may be the same as the porosity of the liquid guiding layer and the equivalent diameter of the microporous structure in the existing atomization core.

The porous cover layer 12 is disposed on the liquid outlet surface side of the dense substrate liquid guiding layer 11. The porous cover layer 12 has a liquid supply portion 121, and the liquid supply portion 121 has a second microporous structure A2. At least part of the first microporous structure A1 of the dense substrate liquid guiding layer 11 is in fluid communication with the second microporous structure A2.

The fluid communication means that a substance having fluidity such as liquid or slurry may flow and transmit between pipelines or channels in two or more components.

The dense substrate liquid guiding layer 11 and the porous cover layer 12 are both insulated from the heating element 13.

A material of the dense substrate liquid guiding layer 11 includes, but is not limited to, dense ceramics, dense glass, and the like. The definition of the dense substrate liquid guiding layer 11 is that the porosity is less than 10%, except for micro-manufactured pores (the first microporous structure A1).

The material of the porous cover layer 12 includes, but is not limited to, at least one of quartz glass, metal, ceramics, a cotton core, and a fiber braid material.

When the material of the porous cover layer 12 is a rigid material such as the quartz glass, the metal, or the ceramics, the porous cover layer 12 is fixedly connected to the dense substrate liquid guiding layer 11, thereby facilitating improving structural stability of the atomization core 10.

Specifically, a manner of fixedly connecting the porous cover layer 12 to the dense substrate liquid guiding layer 11 may be snap connection, bonding, or the like. Alternatively, the porous cover layer 12 and the dense substrate liquid guiding layer 11 may both have a connection structure, and the porous cover layer 12 is fixedly connected to the dense substrate liquid guiding layer 11 by using the connection structures.

When the material of the porous cover layer 12 includes a metal material, the resistance of the metal material is less than 1/10 of that of the heating element 13, to avoid affecting the atomizing of the to-be-atomized substrate by the heating element 13.

In a case that the dense substrate liquid guiding layer 11 and the porous cover layer 12 are processed and formed by a dense substrate, the microporous structures on the dense substrate liquid guiding layer 11 and the porous cover layer 12 are formed by a plurality of micro-manufactured through holes provided on a dense substrate. The micro-manufactured through holes refer to regular pore-like channels that are formed by penetrating from one side of a substrate to the other side by means of laser, etching, machining, and the like. The micro-manufactured through holes have a capillarity force.

Certainly, the porous cover layer 12 may alternatively be formed by processing a disordered porous substrate. Specifically, the disordered porous substrate may be formed by adding a pore-forming agent to ceramic slurry or glass slurry and then sintering, so that a plurality of disordered micro-pores are formed in the formed disordered porous substrate. The disordered micro-pores mean that connections between pores, pore diameters, channel shapes, and spacing between the pores are irregularly distributed, and the disordered micro-pores have a capillarity force.

The porosity of the liquid supply portion 121 in the porous cover layer 12 may be the same as or different from that of the overall porous cover layer 12. In addition, the equivalent pore diameter of the second microporous structure A2 located in the liquid supply portion 121 may be the same as or different from that of the second microporous structure A2 in another area of the porous cover layer 12.

It is to be noted that because the shapes of micro-pores in the dense substrate liquid guiding layer 11 and the porous cover layer 12 are not uniformly stipulated. Therefore, the diameter of the micro-pores in this application is represented by using an equivalent diameter. Specifically, the equivalent diameter is a parameter for describing a non-circular pore or a pore having a complex geometric shape, and can simplify these pores into an equivalent circular pore for analysis, thereby simplifying a complex geometric structure into a form that is easier to process.

For example, in some embodiments of this application, the cross section of the second microporous structure A2 is at least one of a strip (referring to FIG. 7), a circle (referring to FIG. 5), an ellipse, a rhombus, or a rectangle. Therefore, for ease of representation, the pore diameter of the second microporous structure A2 is converted into an equivalent pore diameter.

It is to be noted that, in this embodiment of this application, the porosity of the liquid supply portion 121 is greater than that of the dense substrate liquid guiding layer 11, the equivalent diameter of the second microporous structure A2 in the porous cover layer 12 is greater than that of the first microporous structure A1 in the dense substrate liquid guiding layer 11.

The heating element 13 is configured to heat and atomize the to-be-atomized substrate on the dense substrate liquid guiding layer 11 and the porous cover layer 12. The structure of the heating element 13 includes, but is not limited to, a heating film, a heating wire, a heating mesh, or the like. The material of the heating element 13 includes, but is not limited to, a common electrothermal metal or alloy such as stainless steel, platinum, aluminum, or iron-chromium-aluminum. Specifically, the thickness, the resistance, and the material of the heating element 13 are related to the atomization efficiency and reliability of the atomization core 10, the taste of the aerosol, and the like. Specific parameters are not limited herein, and are specifically designed according to actual requirements.

In this embodiment of this application, the heating element 13 includes a heating portion 131 and a pin portion 132.

The resistance of the pin portion 132 is far less than that of the heating portion 131. For example, the resistance of the pin portion 132 is less than 1/10 of that of the heating portion 131, so that the pin portion 132 has excellent electrical conductivity. Because the pin portion 132 and the heating portion 131 are connected in series for use, when the overall heating element 13 is powered, the heating portion 131 can generate a large amount of heat, and the heat generated on the pin portion 132 may be relatively ignored.

Specifically, in this embodiment of this application, the porous cover layer 12 is further disposed on the rigid dense substrate liquid guiding layer 11, and at least part of the first microporous structure A1 in the dense substrate liquid guiding layer 11 is in fluid communication with the second microporous structure A2 in the porous cover layer 12, the porous cover layer 12 can absorb the to-be-atomized substrate from the dense substrate liquid guiding layer 11, and absorb the to-be-atomized substrate that is free in an atomization process by the heating element 13. In addition, the porosity of the liquid supply portion 121 is greater than that of the dense substrate liquid guiding layer 11, and the equivalent diameter of the second microporous structure A2 is greater than that of the first microporous structure A1. Therefore, the liquid supply portion 121 can form a thicker liquid film by using the surface tension of liquid, thereby cracking to form relatively large-sized atomized liquid drops in the atomization process, facilitating improving the taste of aerosols, and further improving user experience.

For ease of illustration, in this embodiment of this application, the dense substrate liquid guiding layer 11 and the porous cover layer 12 are both formed by providing micro-manufactured through holes on the dense liquid guiding substrate. That is, the first microporous structure A1 and the second microporous structure A2 are micro-manufactured through holes.

In some embodiments, the thickness of the dense substrate liquid guiding layer 11 ranges from 0.3 mm to 5 mm. For example, 0.3 mm, 1 mm, 2 mm, 3 mm, 4 mm, or 5 mm.

The porosity of the dense substrate liquid guiding layer 11 ranges from 20% to 80%. For example, 20%, 40%, 60%, or 80%.

The equivalent diameter of the first microporous structure A1 on the dense substrate liquid guiding layer 11 ranges from 30 μm to 200 μm. For example, 30 μm, 50 μm, 100 μm, 150 μm, or 200 μm. Specifically, the thickness and the porosity of the dense substrate liquid guiding layer 11 and the equivalent diameter of the first microporous structure A1 are related to the liquid guiding efficiency, the atomization efficiency, and the like of the atomization core 10. Specific parameters are not limited herein, and are specifically designed according to actual requirements.

In some embodiments, the porosity of the liquid supply portion 121 is at least twice greater than that of the dense substrate liquid guiding layer 11. For example, the porosity of the liquid supply portion 121 is twice, three times, five times, or the like greater than that of the dense substrate liquid guiding layer 11. This is not limited herein, and is specifically designed according to actual requirements. In addition, in this embodiment, the equivalent diameter of the second microporous structure A2 may be equal to or greater than that of the first microporous structure A1 in the dense substrate liquid guiding layer 11.

In some embodiments, the equivalent diameter of the second microporous structure A2 in the porous cover layer 12 is at least twice greater than that of the first microporous structure A1 in the dense substrate liquid guiding layer 11. For example, the equivalent diameter of the second microporous structure A2 is at least twice, three times, five times, or the like greater than that of the first microporous structure A1. This is not limited herein, and is specifically designed according to actual requirements. In addition, in this embodiment, the porosity of the liquid supply portion 121 may be equal to or twice greater than that of the dense substrate liquid guiding layer 11.

Specifically, it is set that the porosity of the liquid supply portion 121 is at least twice greater than that of the dense substrate liquid guiding layer 11; and/or it is set that the equivalent diameter of the second microporous structure A2 in the porous cover layer 12 is at least twice greater than that of the first microporous structure A1 in the dense substrate liquid guiding layer 11, so that the liquid supply portion 121 can form a thicker liquid film by using the surface tension of liquid, thereby cracking to form relatively large-sized atomized liquid drops in an atomization process, facilitating improving the taste of aerosols, and further improving user experience.

In some embodiments, the orthographic projection of the liquid supply portion 121 on the dense substrate liquid guiding layer 11 covers the orthographic projection of the heating portion 131 of the heating element 13 on the dense substrate liquid guiding layer 11. For example, the liquid supply portion 121 may cover the heating element 13 and at least part area of the dense substrate liquid guiding layer 11 that is not covered by the heating element 13, thereby facilitating absorbing liquid of the liquid supply portion 121 from the dense substrate liquid guiding layer 11.

Alternatively, the liquid supply portion 121 may cover the heating portion 131 and the pin portion 132. It is to be noted that the heating portion 131 between the dense substrate liquid guiding layer 11 and the liquid supply portion 121 has liquid guiding pores, and the dense substrate liquid guiding layer 11 may be in fluid communication with the liquid supply portion 121 through the liquid guiding pores in the heating portion 131.

Alternatively, the liquid supply portion 121 only covers the heating portion 131, and the dense substrate liquid guiding layer 11 may be in fluid communication with the liquid supply portion 121 through the liquid guiding pores in the heating portion 131. Specifically, because the heat generated by the pin portion 132 cannot atomize a to-be-atomized substrate, the liquid supply portion 121 is disposed to cover the heating portion 131, to supply liquid to the heating portion 131, and the pin portion 132 exposes the liquid supply portion 121, so as to facilitate electrical connection between the pin portion 132 and an external circuit.

In some embodiments, the porosity of the area of the liquid supply portion 121 aligned with the heating portion 131 is greater than or equal to 50%. For example, the porosity of the area of the liquid supply portion 121 aligned with the heating portion 131 may be 50%, 70%, 90%, or the like. This is not limited herein, and may be specifically designed according to actual requirements.

Specifically, it is set that the porosity of the area of the liquid supply portion 121 aligned with the heating portion 131 is greater than or equal to 50%, to facilitate buffering more to-be-atomized substrate by the liquid supply portion 121, thereby forming a thicker liquid film by using the surface tension of liquid of the to-be-atomized substrate, cracking to form relatively large-sized atomized liquid drops in an atomization process, facilitating improving the taste of aerosols, and further improving user experience.

In some other embodiments, the equivalent diameter of the second microporous structure A2 ranges from 100 μm to 1500 μm. For example, the equivalent diameter of the second microporous structure A2 may be 100 μm, 300 μm, 600 μm, 900 μm, 1200 μm, 1500 μm, or the like. This is not limited herein, and may be specifically designed according to actual requirements.

The equivalent pore diameter of the plurality of second microporous structures A2 may be completely the same or may not be completely the same, which may specifically select according to an actual process and a design requirement.

Specifically, if the equivalent diameter of the second microporous structure A2 is excessively small, the liquid supply portion 121 absorbs less to-be-atomized substrate, and it is difficult to form a relatively thick liquid film on the surface of the heating element 13. Consequently, it is difficult to improve use experience. If the equivalent diameter of the second microporous structure A2 is excessively large, the capillarity force is weakened. Consequently, the capillarity force is not strong, and it is difficult to meet a requirement of locking a liquid to form an oil film.

Specifically, in this embodiment of this application, it is set that the equivalent diameter of the second microporous structure A2 ranges from 100 μm to 1500 μm. The second microporous structure A2 can further facilitate forming a relatively thick oil film while ensuring sufficient capillarity force to lock a liquid, so as to form relatively large-sized atomized liquid drops in the atomization process. The relatively large-sized atomized liquid drops in aerosols are easily remained in the oral cavity of a user, thereby facilitating improving the taste of the aerosols, and further improving user experience.

In some embodiments, the thickness of the liquid supply portion 121 ranges from 20 μm to 400 μm. For example, the thickness of the liquid supply portion 121 may be 20 μm, 50 μm, 80 μm, 100 μm, 200 μm, 300 μm, 400 μm, or the like. This is not limited herein, and may be specifically designed according to actual requirements.

Specifically, if thickness of the liquid supply portion 121 is too small, it is difficult to form a liquid film or it is difficult to form large liquid drops during atomizing; and if the thickness of the liquid supply portion 121 is too large, it is not easy to atomize, it is prone to incomplete atomization and increases a liquid leakage risk.

Referring to FIG. 3 and FIG. 4, in some embodiments, the heating portion 131 of the heating element 13 is disposed between the liquid supply portion 121 and the dense substrate liquid guiding layer 11. The spacing between the heating portion 131 and the liquid supply portion 121 ranges from 0 to 200 μm.

For example, referring to FIG. 3, the liquid supply portion 121 fits the dense substrate liquid guiding layer 11, and the heating portion 131 is sandwiched between the liquid supply portion 121 and the dense substrate liquid guiding layer 11. That is, in this embodiment, the spacing between the heating portion 131 and the liquid supply portion 121 is 0. This design facilitates absorbing the to-be-atomized substrate from the dense substrate liquid guiding layer 11 by the liquid supply portion 121 and facilitates atomizing the oil film formed on the liquid supply portion 121 by the heating portion 131, thereby improving liquid guiding efficiency and atomization efficiency.

For another example, referring to FIG. 4, the heating portion 131 fits the liquid outlet surface of the dense substrate liquid guiding layer 11, and the heating portion 131 is spaced away from the liquid supply portion 121. The spacing between the heating portion 131 and the liquid supply portion 121 is less than or equal to 200 μm. For example, the spacing between the heating portion 131 and the liquid supply portion 121 may be 10 μm, 50 μm, 100 μm, 150 μm, 200 μm, or the like. This is not limited herein, and may be specifically designed according to actual requirements. The spacing between the heating portion 131 and the liquid supply portion 121 is designed to be less than or equal to 200 μm, and a capillarity force is provided within the spacing range, so that the to-be-atomized substrate in the dense substrate liquid guiding layer 11 can be absorbed to a gap area between the liquid supply portion 121 and the heating portion 131 through the capillarity force, thereby facilitating forming a relatively thick oil film, and cracking to form relatively large-sized liquid drops during an atomization process. The relatively large-sized atomized liquid drops in aerosols are easily remained in the oral cavity of a user, thereby facilitating improving the taste of the aerosols, and further improving user experience.

To implement that the heating portion 131 is spaced away from the liquid supply portion 121, in some embodiments, referring to FIG. 4 and FIG. 7, the porous cover layer 12 further includes a support portion 122 located outside an area of the liquid supply portion 121. The support portion 122 is of a continuous and seamless structure to improve rigidity and stability of the support portion 122. The support portion 122 and the liquid supply portion 121 are located at on the same horizontal plane. The surface of the support portion 122 close to the dense substrate liquid guiding layer 11 has a protruding portion 123, and the heating portion 131 is spaced away from the liquid supply portion 121 by the protruding portion 123.

There may be one support portion 122, and one support portion 122 is annular and disposed around the liquid supply portion 121. Alternatively, there may be two support portions 122, and the two support portions 122 are respectively disposed on the opposite two sides of the liquid supply portion 121 (with reference to FIG. 4 and FIG. 7). Alternatively, there may be a plurality of support portions 122, and the plurality of support portions 122 are disposed around the periphery of the liquid supply portion 121.

Refer to FIG. 8, which is a schematic structural diagram of an atomization core according to still another embodiment of this application. In some embodiments, the atomization core 10 further includes a binding layer 14. The binding layer 14 is disposed between the heating element 13 and the dense substrate liquid guiding layer 11. The binding layer 14 is configured to reliably bind the heating element 13 and the dense substrate liquid guiding layer 11.

Specifically, the binding layer 14 basically uses an organic material. To ensure reliability, the requirements on binding strength, consistency, and stability are very high (if the heating element 13 and the dense substrate liquid guiding layer 11 are not bound and have a gap, a problem easily occurs in heat conduction in this area, resulting in a relatively high temperature and scorching). Therefore, the requirement on consistency of coefficients of thermal expansion of the dense substrate liquid guiding layer 11 and the heating element 13 is high. This limits application of many types of substrates.

In a preparation manner of this application, slurry of the binding layer 14 is printed on one surface of the heating element 13, and the heating element 13 is pasted to the liquid outlet surface of the dense substrate liquid guiding layer 11 by using the slurry of the binding layer 14, and then is sintered, to form the binding layer 14 located between the heating element 13 and the dense substrate liquid guiding layer 11.

The binding layer 14 connected between the heating element 13 and the dense substrate liquid guiding layer 11 is formed by sintering. The binding layer 14 can improve the stability and endurance of the atomization core 10. Specifically, the heating element 13 may be fixedly fixed to the dense substrate liquid guiding layer 11 by a sintering process, to form a stable overall structure, which reduces falling off or damage caused by vibration or mechanical stress during use, thereby prolonging the service life of the atomization core 10.

In this embodiment of this application, the binding layer 14 is formed by one or more types of organic oxides. The binding layer 14 is printed on one side of the heating element 13 in a manner of being preparing into slurry, is sintered after being firmly bound to the dense substrate liquid guiding layer 11, and is firmly bound to the liquid outlet surface of the dense substrate liquid guiding layer 11.

In addition, in this embodiment of this application, an area of the binding layer 14 corresponding to the first microporous structure A1 has corresponding liquid guiding pores, so as to prevent the binding layer 14 from affecting liquid supply of the dense substrate liquid guiding layer 11 to the heating element 13 and the porous cover layer 12.

The above are only implementations of this application, and do not limit the patent scope of this application. All equivalent structure or equivalent process transformation made by using the contents of the description and accompanying drawings of this application, or directly or indirectly applied to other related technical fields is similarly included in the patent protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomization core, comprising:
a dense substrate liquid guiding layer having a liquid inlet surface and a liquid outlet surface that are oppositely disposed, a first microporous structure that penetrates through the liquid inlet surface and the liquid outlet surface being provided on the dense substrate liquid guiding layer, the first microporous structure being configured to conduct and buffer a to-be-atomized substrate;
a porous cover layer disposed on a liquid outlet surface side of the dense substrate liquid guiding layer, the porous cover layer having a liquid supply portion having a second microporous structure, at least part of the first microporous structure in the dense substrate liquid guiding layer being in fluid communication with the second microporous structure, a porosity of the liquid supply portion being greater than a porosity of the dense substrate liquid guiding layer, and an equivalent diameter of the second microporous structure being greater than an equivalent diameter of the first microporous structure; and
a heating element disposed between the dense substrate liquid guiding layer and the liquid supply portion, the heating element being configured to atomize the to-be-atomized substrate.

2. The atomization core of claim 1, wherein at least one of:
the porosity of the liquid supply portion is at least twice that of the porosity the dense substrate liquid guiding layer, and
the equivalent diameter of the second microporous structure in the porous cover layer is at least twice that of the equivalent diameter of the first microporous structure in the dense substrate liquid guiding layer.

3. The atomization core of claim 1, wherein the heating element comprises a heating portion and a pin portion, the heating portion being configured to atomize the to-be-atomized substrate, and
wherein a porosity of the area of an liquid supply portion aligned with the heating portion is greater than or equal to 50%.

4. The atomization core of claim 1, wherein the equivalent diameter of the second microporous structure ranges from 100 μm to 1500 μm.

5. The atomization core of claim 1, wherein a thickness of the liquid supply portion ranges from 20 μm to 400 μm.

6. The atomization core of claim 1, wherein an orthographic projection of the liquid supply portion on the dense substrate liquid guiding layer covers an orthographic projection of the heating portion of the heating element on the dense substrate liquid guiding layer.

7. The atomization core of claim 1, wherein a spacing between the heating portion and the liquid supply portion ranges from 0 to 200 μm.

8. The atomization core of claim 7, wherein the porous cover layer comprises a support portion located outside an area of the liquid supply portion, the support portion comprising a continuous and seamless structure, the support portion and the liquid supply portion being located on a same horizontal plane,
wherein a surface of the support portion close to the dense substrate liquid guiding layer has a protruding portion, and
wherein the heating portion is spaced away from the liquid supply portion by the protruding portion.

9. The atomization core of claim 1, wherein a material of the porous cover layer comprises at least one of quartz glass, metal, ceramics, a cotton core, and a fiber braid material.

10. The atomization core of claim 9, wherein the porous cover layer is fixedly connected to the dense substrate liquid guiding layer.

11. The atomization core of claim 1, wherein a cross section of the second microporous structure comprises at least one of a strip, a circle, an ellipse, a rhombus, and a rectangle.

12. An atomizer, comprising:
a housing, having a liquid storage cavity; and
the atomization core of claim 1, the atomization core being in fluid communication with the liquid storage cavity.

13. An electronic atomization apparatus, comprising:
the atomizer of claim 12; and
a main unit configured to supply power to and control the atomizer.
